(19) United States
(12) Patent Application Publication
(10) Pub. No.: US 2024/0034476 A1
(43) Pub. Date: Feb. 1, 2024

(54) PRECISION GUIDED MANNEQUIN ARIAL UNIT

(71) Applicant: Mark Kusbel, Peoria, AZ (US)

(72) Inventor: Mark Kusbel, Peoria, AZ (US)

(21) Appl. No.: 18/128,646

(22) Filed: Mar. 30, 2023

Related U.S. Application Data
(60) Provisional application No. 63/325,476, filed on Mar. 30, 2022.

(51) Int. Cl. B64D 21/00

(52) U.S. Cl. CPC B64D 21/00

(57) ABSTRACT

Disclosed is a guided mannequin aerial unit. The mannequin includes a control unit having a central processing unit (CPU), memory for storing a computer software instruction set for execution by the CPU, a high-resolution camera for taking and providing to the CPU real time images of the drop area and a second memory unit for pre-storing images of the mannequin drop area and the drop target. Under the control of the software instruction set, the CPU compares the real time images to the pre-stored images to guide the mannequin to the drop target.

### CROSS-REFERENCE TO RELATED APPLICATION

The present application claims priority to provisional patent application Ser. No. 63/325,476 filed on Mar. 30, 2022 and is entitled “Precision Guided Torso Aerial Unit”, said application being fully incorporated herein by reference, and to provisional patent application Ser. No. 63/325,478 also filed on Mar. 30, 2022 and is entitled “Joint Precision Air Drop System”, said application being fully incorporated herein by reference.

### TECHNICAL FIELD

The present invention generally relates to the field of aerial guidance systems, and more particularly is directed to a precision guided mannequin aerial unit.

### SUMMARY OF THE INVENTION

The guided torso, or mannequin, of the present invention has a number of applications for parachute testing and where parachute drops must be made with a great deal of precision as to landing target.

For example, the guided mannequin of the present invention may be used for personal parachute system testing, parachute development, incident investigation and the like. The mannequin uses the same parachute system as a normal parachute jumper and can be weighed as needed depending on the particular parameters under consideration.

The mannequin of the present invention greatly reduces risk of injury in parachute testing.

### BRIEF DESCRIPTION OF THE DRAWINGS

The novel features of the present invention will be understood more fully and clearly from the following detailed description of the invention as set forth in the accompanying drawings in which:

FIG. 1 is an over-all illustration of one embodiment a mannequin in accordance with the present invention; and

FIG. 2 is a block diagram of one embodiment of a control and guidance unit for the mannequin shown in FIG. 1.

### DESCRIPTION OF THE PREFERRED EMBODIMENT

A preferred embodiment of the present invention will be described with reference to the drawings.

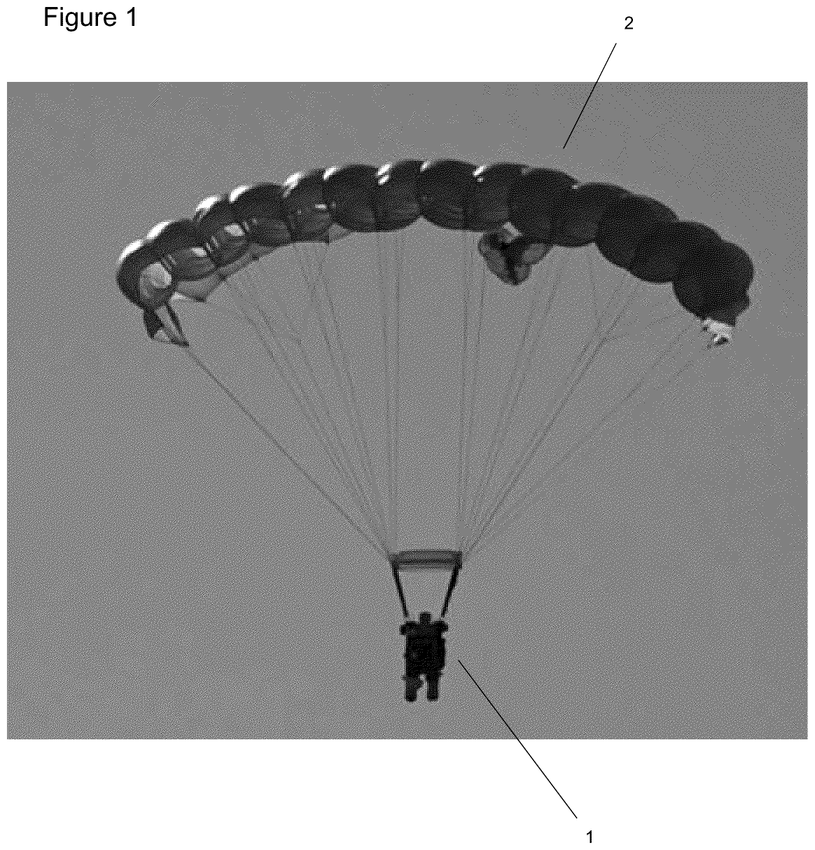

FIG. 1 illustrates the mannequin or torso 1 deployed under a parachute 2 during a parachute jump. As can be seen in FIG. 1, the mannequin is formed to replicate the form of a human body and is tethered to parachute 2 in the same manner as a human jumper.

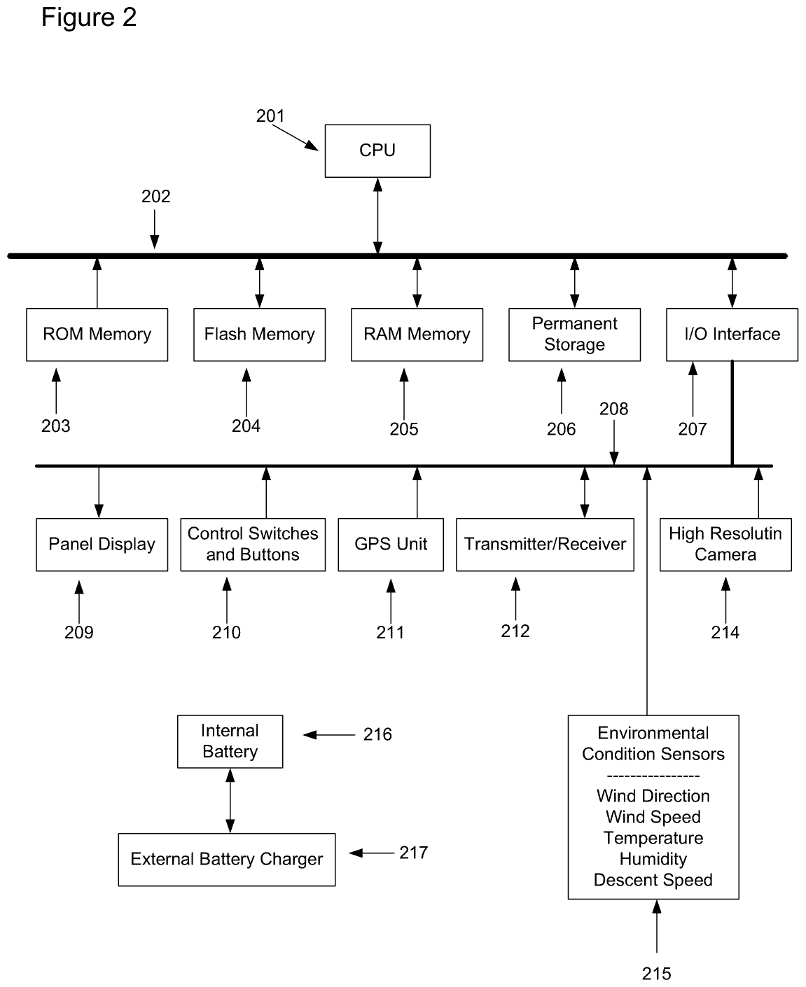

A guidance and control unit can be integrated into the chest cavity of the mannequin. One embodiment of such a unit is depicted in block diagram form in FIG. 2.

As illustrated in FIG. 2, the control unit includes a CPU 201 which is used to execute computer software instructions as is known in the art. CPU 201 is coupled, via buss 202, to ROM Memory 203, Flash Memory 204, RAM Memory 205, Permanent Storage 206 and I/O Interface 207.

ROM Memory 203 and Flash Memory 204 may be used to store computer software instructions for execution by CPU 201. RAM memory 205 may also be used for storing computer software instructions, and especially for storing information that is only needed for a short period of time. Permanent Storage 206 is used for longer and larger data storage and its data may be transferred to a central data store for analysis after a drop mission. Such data may include continuously updated real time system performance information during the course of a parachute drop using the mannequin of the present invention.

RAM memory 205 and/or Permanent Storage 206 is also used to store pre-loaded satellite imagery of the designated area area and drop target.

The underlying firmware or software which CPU 201 executes may be updated from time to time in order to correct programming errors or to add additional features to the system.

As shown in FIG. 2, CPU 201 is also coupled to a number of peripheral interface devices via I/O Interface 207 and its own buss 208.

Panel Display 209 may be used to provide system and other information to system operators. Control Switches and Buttons 210 may be used by system operators to enter commands into the Control Unit 4.

GPS Unit 211 is used to receive GPS data.

Transmitter/Receiver 212 may be used for a system operator to communicate with the system.

High Resolution Camara 214 is used to take real time images of the drop area which can then be analogize for guidance purposes. Environmental Conditions Sensors 215 is used to measure a number of environmental conditions, including wind direction, wind speed, temperature, humidity and descent speed during a drop operation.

The system is powered by Internal Battery 216 which can be recharged by External Battery Charger 217.

High Resolution Camera 214 continuously takes images of the surrounding area and CPU 201 compares these images to the above mentioned pre-stored image data with the designated mannequin drop target. This information is then used by CUP 201 to guide Parachute 2 to the drop target. The system can also be supplemented with GPS data from GPS Unit 211 and from Environmental Condition Sensors 215.

The mannequin of the present invention can be weighted from 250-600 pounds and Transceiver/Receiver 212 can operate in the 900 MHz range to provide telemetry, real time monitoring and remote-control operation of the mannequin. Such capabilities allow remote control of the mannequin to explore performance envelopes that may be otherwise dangerous to humans.

In addition, any number of parachute configuration parameters can be unloaded into the control unit for the purposes of testing an infinite range of parachute types, replicate failure scenarios, and develop new parachute systems, rigging techniques, or failure modes.

While the foregoing specification and drawings teaches the principles of the present invention, with examples provided for the purpose of illustration, it will be appreciated by one skilled in the art from reading this disclosure that various changes in form and detail can be made without departing from the true scope of the invention.

I claim:

1. A guided mannequin aerial unit, said unit comprising:
a structure resembling the form of a human torso;
a control unit mounted within said structure, said control unit comprising:
a central processing unit (CPU);
a first memory unit coupled to said CPU for storing a computer software instruction set for execution by said CPU;
a camera coupled to said CPU for taking and providing to said CPU real time images of said drop area;
a second memory unit coupled to said CPU for pre-storing images of said drop area and said drop target; and
wherein said CPU executing said software instruction set compares said real time images to said pre-stored images to control and guide said structure to said drop target.
